(19) United States
(12) Patent Application Publication
(10) Pub. No.: US 2002/0184418 A1
(43) Pub. Date: Dec. 5, 2002

(54) Location mapping and determining using wireless devices

(75) Inventor: David Blight, Santa Clara, CA (US)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/867,907

(22) Filed: May 30, 2001

(51) Int. Cl. G06F 13/00

(52) U.S. Cl. 710/100

(57) ABSTRACT

A system and method for providing location mapping and location determining is disclosed. The system and method use known location of other nearby devices to determine the location of a mobile wireless device.

### BACKGROUND OF THE INVENTION

Handheld computing devices, “palmtops,” “palmhelds,” personal digital assistants (PDAs), or handheld computers typically weigh less than a pound and fit in a pocket. These handhelds generally provide some combination of personal information management, database functions, word processing, and spreadsheets as well as voice memo recording, wireless e-mail, and wireless telephony functions.

Handheld computers may include hardware modules which allow a user to access and communicate wirelessly with both wired and wireless communications networks. Such networks may include Local Area Networks (LANs) and Personal Area Networks (PANs).

In certain situations it may be desirable to determine the location of a mobile device or a mobile device user within or near an area served by a communications network.

Conventionally one of the following techniques to determine the location of a mobile device is used:

Global Positioning System (GPS) receiver in the mobile device.

GPS receiver in the mobile device, augmented with data from network.

Triangulation from base stations.

Timing analysis of signals.

GPS receiver in a connected device (e.g., a Bluetooth connection to a GPS enabled phone).

Signal power analysis.

Location Information from neighboring devices (containing GPS or other mechanisms).

Each of these techniques has advantages and disadvantages. Accordingly, there is a need for a wireless mobile device system and method that is configured to achieve better resolution of location accuracy. There is also a need for a wireless mobile device that exploits information about other nearby devices to achieve better resolution of location accuracy.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the above-mentioned needs.

### SUMMARY OF THE INVENTION

An exemplary embodiment relates to a method of determining location of a mobile device having a radio frequency (RF) transceiver. The method includes gathering a list of addresses of nearby devices in communications with a network. The method also includes sending a location request to a location service accessible through the network accessed wirelessly by the mobile device. Further, the method includes accessing a database of known device locations and correlating the list of addresses with zone information of the database.

Another exemplary embodiment relates to a method of determining location of a mobile device having a radio frequency (RF) transceiver. The method includes receiving a location request from a mobile device over a communications network. The method also includes receiving from a mobile device a list of addresses of devices nearby the mobile device that are in communications with the communications network. Further, the method includes accessing a database of known device locations. Further still, the method includes correlating the list of addresses with zone information of the database and sending a location estimation to the mobile device.

Yet another exemplary embodiment relates to a method of determining location of a mobile device having a radio frequency (RF) transceiver. The method includes gathering a list of addresses of nearby devices in communications with a communications network. The method also includes sending a location request to a location service accessible through the network accessed wirelessly by the mobile device, the location service being configured to access a database of known device locations and to correlate the list of addresses with zone information of the database. Further, the method includes receiving from the location service a location estimation of the mobile device.

Still yet another exemplary embodiment relates to a system for locating a wireless device in wireless communications with a communications network. The system includes access points coupled to the communications network and being configured to communicate with the wireless device. The system also includes at least one other device in communication with the communications network. Further, the system includes a server coupled to the communications network, the server configured to receive location requests from the wireless device, the location request including a list of addresses of devices coupled to the communications network that are nearby the wireless device, the server configured to correlate the list of addresses with an estimated location, and the server is configured to send the estimated location to the wireless device.

Further, an exemplary embodiment relates to a method for developing a database for a location determination service. The method includes building a map of an area served by a network. The method also includes entering the locations of stationary and permanent devices and the associated device addresses into a database. Further, the method includes recording, using a test device, multiple locations accessible wireless addresses. Further still, the method includes combining the map, the locations of stationary and permanent devices, and the accessible locations into the database and defining coverage zones of the area served by the network.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a front elevation view of a handheld computer;

FIG. 2 is a block diagram of a communications network system;

FIG. 3 is a process diagram depicting a database updating process;

FIG. 4 is a process diagram depicting a location request by a mobile device;

FIG. 5 is an exemplary diagram of an office building floor plan having a plurality of devices located therein;

FIG. 6 is an exemplary diagram of the office building floor plan of FIG. 6 depicting the movement of an administrator during a recording phase;

FIG. 7 is an exemplary diagram of the zones of the office building floor plan of FIG. 6; and

FIG. 8 is an exemplary diagram of one of the zones of the office building floor plan of FIG. 7.

### DETAILED DESCRIPTION OF THE PREFERRED EMBODIMENTS

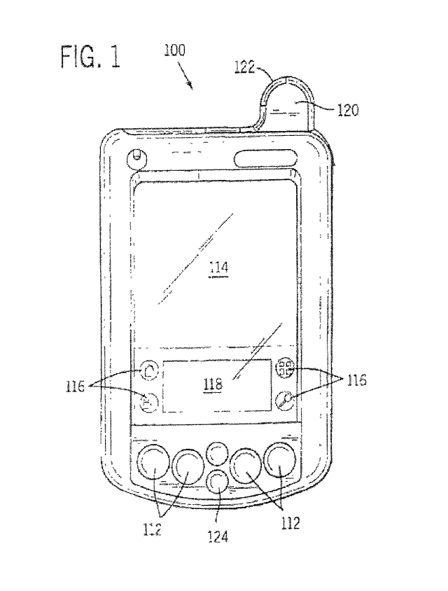

Referring to FIG. 1, a handheld computer 100 is depicted according to an exemplary embodiment. Handheld computer 100 may include Palm style computers manufactured by Palm, Inc., of Santa Clara, Calif. Other exemplary embodiments may include Windows CE handheld computers, or other handheld computers and personal digital assistants, as well as mobile telephones, pagers, and other mobile computing devices.

Preferably, handheld computer 100 includes interactive hardware and software that performs functions such as maintaining calendars, phone lists, task lists, note pads, calculator applications, spreadsheets, games, video files, and other applications capable of running on a computing device. Further, handheld computer 100 may be configured for such functions as voice memo recording and playback as well as communications network connectivity, Internet connectivity, wireless messaging, e-mail, always-on e-mail, and wireless telephony.

Handheld computer 100, depicted in FIG. 1, includes a plurality of input function keys 112 and a display 114 having graphical user interface features. Display 114 may be provided with a touch screen interface that allows a user to select and alter displayed content using a pointer, such as but not limited to a stylus, a pen tip, a fingertip, or other pointing devices.

Referring again to FIG. 1, in an exemplary embodiment, display 114 also includes a Graffiti™ (or other handwriting recognition software) writing section 118 for tracing alpha-numeric characters as input. A plurality of input icons 116 for performing automated or preprogrammed functions may be provided on a portion of display 114.

In an exemplary embodiment, handheld computer 100 may include an integrated antenna 120 configured to transmit and receive wireless communication signals, such as, but not limited to, cellular telephone communication signals and other radio frequency (RF) communications signals using an RF transceiver. Antenna 120 may further include an indicator light 122 integrated into antenna 120 for indicating the transmission and reception of wireless communication signals. Further, light 122 may be used to indicate other states of handheld computer 100. Further, handheld computer 100 may include a wireless transceiver, such as a Bluetooth transceiver or an IEEE 802.11 standard transceiver, or other RF or wireless transceiver, such that handheld computer 100 is configured to communicate with other nearby devices and/or access points to a communications link.

In an exemplary embodiment, handheld computer 100 also includes navigation buttons 124 that may be utilized for navigating or scrolling of information displayed on display 114. Further, navigation buttons 124 may be programmed for other uses depending on the application running on handheld computer 100. Handheld computer 100 may be used for any of a variety of wireless communications, including, but not limited to, communications with the World Wide Web, mobile telephone communications, e-mail communications, etc.

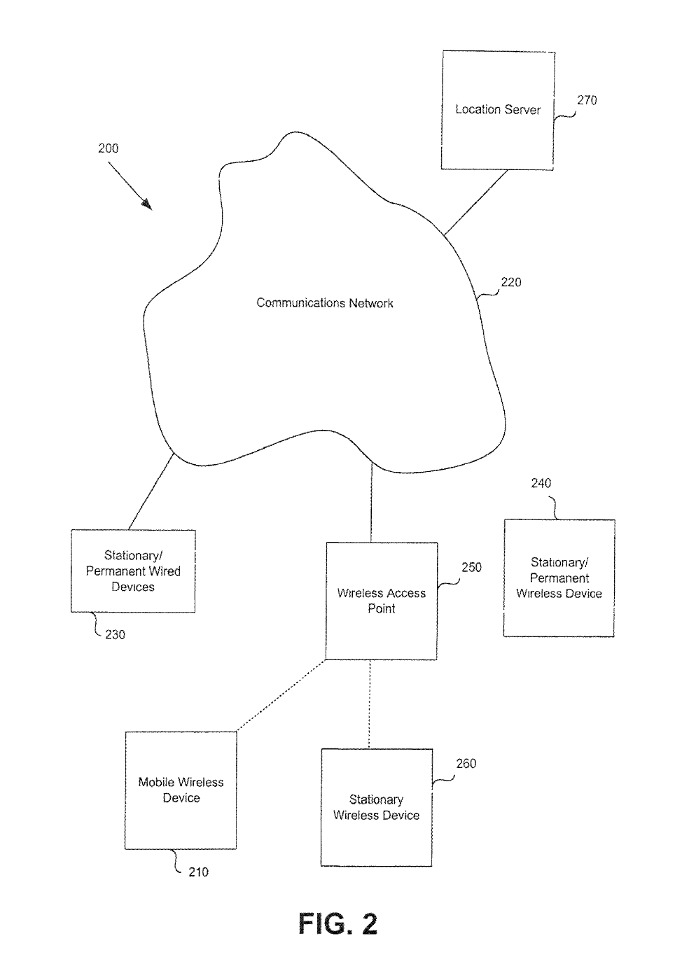

Referring now to FIG. 2, a system 200 which may be used for locating mobile devices, such as mobile wireless device 210, within an environment where Local Area Networks (LANs) are used and/or Personal Area Networks (PANs) or short range wireless systems are deployed, is depicted. System 200 includes a communications network 220 which may be a wired or wireless communications network such as a LAN. Coupled to communications network 220 are stationary wired devices 230, such as but not limited to personal computers, printers, scanners, cameras, terminals, monitors, and the like. Similarly, stationary wireless devices 240 may be located near and around the area served by communications network 220 and may be any of a variety of devices including but not limited to the same types of devices as stationary wired device 230. Further, stationary wireless devices 240 may or may not be in communication with communications network 220. A wireless access point 250 may also be coupled to communication network 220. Wireless access point 250 includes a short range RF transceiver such as, but not limited to a Bluetooth or IEEE 802.11 transceiver, for establishing communications channels between nearby wireless devices, such as but not limited to mobile wireless devices 260. It should be noted that in an exemplary embodiment many or all of devices 230, 240, 250, and 260 include short range wireless transceivers which may communicate with mobile wireless device 210. Accordingly, mobile wireless device 210 is able to determine which devices are in short range wireless communication with device 210 so that the location of wireless device 210 may be refined based on known location of devices 230, 240, 250, and 260, that are stored in a database on a location server 270 that is coupled to communications network 220. When mobile device 210 wishes to determine its location, it sends a request to location server 270 accessible through communications network 220. The request includes the wireless addresses of nearby devices. The additional knowledge of what is close to or nearby the mobile device may aid in determining the location of the mobile device. This additional information may be used in conjunction with the conventional techniques listed above such as GPS, etc.

In an exemplary embodiment, system 200 may have one or more of the following characteristics to improve performance of the location system:

1. Be compatible with other location determination mechanisms (including GPS, network assisted GPS, base station location, etc.)

2. Be able to identify when stationary wireless devices have moved.

3. Be able to handle conflicts in location information.

4. Be able to handle stationary devices turning off and on.

5. Be able to handle new stationary devices being introduced into the network environment.

6. Be able to handle mobile devices in the network environment.

7. Be able to function with different power levels and radiation patterns from different vendor transmitters.

8. Location resolution equal to or greater than simple base station mapping.

9. Be scaleable, potentially dealing with a large number of PANs, and base stations.

In an exemplary embodiment, location server 270 maintains a location database. The location database contains information relating to the location of devices in and around the area served by communications network 220. The location database contains information on the location of permanent devices 230, 240, and 260 (those which do not move), stationary devices 230, 240, and 260 (those which move infrequently), and mobile devices 210 (those which move regularly). Entries in the location database may be automatically discovered, or manually entered.

In an exemplary embodiment location server 270 maintains a list of recognized addresses. This list may be used in filtering addresses in order to separate those addresses in order to separate those addresses representing mobile devices from those addresses representing permanent and stationary devices.

In an exemplary embodiment zones may be identified within an area served by communications network 220. A zone is simply a region of space, with some common feature. In an exemplary embodiment two types of zones may be identified: User and Coverage. A User Zone is one that corresponds to a geographic area defined by a user (e.g., room, hall, lobby, stairs). A Coverage Zone is one that defines an area with consistent coverage properties (any spot in the area has access to the same wireless base station). Each zone may be described by:

Name

Sub Zones

Super Zones

Parent Zone

Type

User defined

Coverage defined

Boundary

Device List Inclusion: A list of devices which should be accessible to this zone.

Device List Exclusion: A list of devices which should NOT be accessible to this zone.

Graphics information (user type only)

Further, in an exemplary embodiment the location database on server 270 may include a device list. Each device entry in the device list may contain:

Wireless Address

Wireless Type

Bluetooth, 802.11, others

Range

Name: Used to identify device, and associate device with records in corporate and network management databases.

Device classification

Base Station, Computer, Printer, Cell Phone, Mobile Device, PDA, unknown, etc.

Mobility Status

Permanent, Stationary, Mobile, unknown

Device Status

On

Off

Moved (device on, location unknown)

Location

Zone List: List of Zones which can access device

Base Station access list (base station only)

Devices in range of this base station

Location history: a list of locations and times associated with device

Zones

Timestamp

Change flag (indicates status change)

New flag

Further, in an exemplary embodiment the location database on server 270 may include a graphics map. A graphics map is the data structure which contains the visual information about an area. The graphics map may consist of a tree structure of zones (user type). Each zone has graphic information which can be used in rendering a map of the zone.

To prepare the location database of server 270 a database initialization process may occur. The database initialization process may include but is not limited to the following four phases.

Phase 1: Building Map—A hierarchical graphical description of the location area may be entered. This may be manually done, or imported from other maps and/or databases.

Phase 2: Stationary and Permanent Device Locations—The locations of stationary and permanent devices and addresses may be entered into the database.

Phase 3: Location Mapping—A test device may be used to record at multiple locations the accessible wireless addresses.

Phase 4: Location Database Creation—the information from the first three phases may be combined to complete the database. During this phase, the location mapping measurements from phase 3 may be used. Cluster analysis may be used to find clusters of spatially close records having common wireless access. Each of these clusters may be used to define a Coverage type zone. These Coverage Zones may be added to the database.

In an exemplary case where no recordings were made (phase 3 was not performed), Virtual measurements may be calculated based on the location of permanent base stations, and their estimated coverage. Phase 3 may be repeated more than once to detect and/or eliminate errors during initialization.

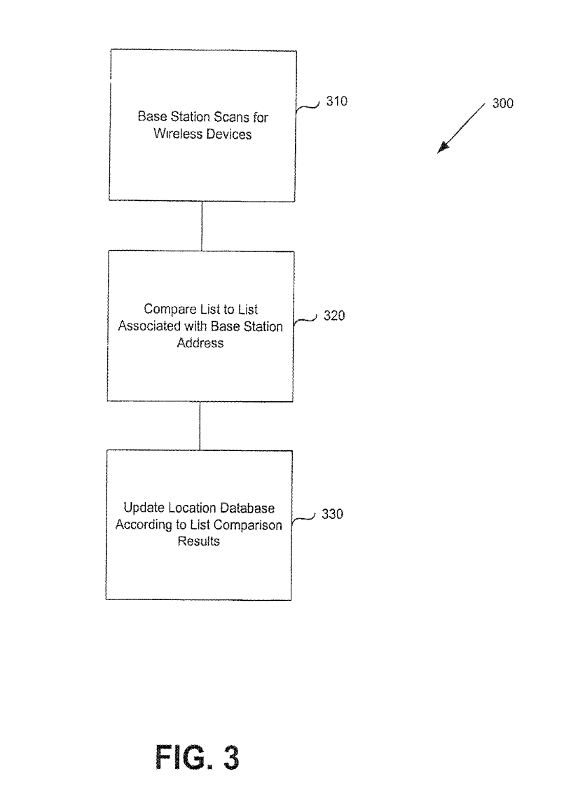

Referring now to FIG. 3, in operation periodically each network base station may be allowed to scan for wireless devices (step 310) in a process 300. This scanning should be done at an interval that does not interfere with its normal operation. Each base station scans to see all Bluetooth (or other wireless transceiver) addresses within range. The list of devices may be compared to the list associated with the base station device (step 320). If a new device is located (one whose address is unknown), an unknown device entry is made in the device table. Change is set. New Flag is also set. If an existing device now appears where it did not before, the device is flagged as moved and changed. If an existing device is now missing from an access point where it was before, its status is marked as off, and changed. If an existing device in off state is detected, the device is marked on, and changed. Once all base stations/access points are scanned, the location database is updated (step 330).

Further, it may be desirable to make changes on the mobile device itself. For example, for each device, if the change flag is set: update history list. If device status is moved and if current location is stable, change state to stationary, otherwise unset change flag.

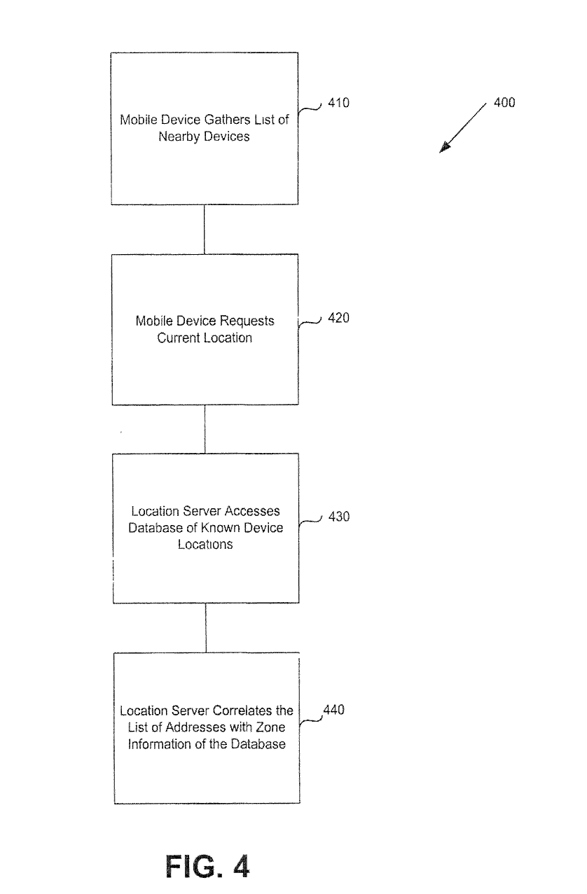

Referring now to FIG. 4, a process 400 is depicted for determining the location of a mobile device. A mobile device gathers a list of nearby devices which are in short range RF communication with the mobile device (step 410). The mobile device may ask the network for its current location (step 420).

In an exemplary embodiment the request for current location may include the following information:

List of wireless device addresses near the mobile device (optional)

Current position (optional)

This position may be determined by embedded GPS or other means

The request for location may be used to obtain higher resolution specification

The response from the location server may include

Estimated position

Text based location description

The mobile device may also (optionally) tell the network where it is, or inform the network that the position in its response was incorrect.

When a request is received to identify the location of a mobile device, the database must be searched (step 430) to find the zone (coverage and/or user) in which the mobile device is in and to correlate the list of addresses nearby the mobile device with a particular zone (step 440). Each zone maintains a list of addresses which may and may not be in the zone. The basic problem may be to match the nearby addresses with the zone information of the database. Some specific difficulties that apply specifically to this problem include:

Errors due to movement of stationary devices

Differing coverage range of mobile devices

Dynamic nature of environment

Multiple matching zones, i.e., may be possible to have two disjoint zones with same matching criteria

There are many different specific algorithms which may be used to find the best matching zone. The specific algorithm which will be best will depend upon the size of the area, the wireless technology options, other location determination mechanism also employed, and the number of wireless devices. Some algorithms which could be used to rapidly search the database include but are not limited to:

Sequential search, i.e., search each entry, return all matches. This algorithm may be suitable for small geographic spaces, with small numbers of wireless devices.

Hierarchical Search. Some characteristics of the hierarchical search may include:

Zone database should be hierarchical with permanent zones distinguished by permanent addresses located higher in the tree than stationary. Larger coverage base station should also be higher in the tree than lower coverage areas.

Match inclusion lists before exclusion lists (detecting an address is more significant than not detecting an address)

The first lowest level matching entry is returned.

In an exemplary embodiment a test device may be used to validate device locations and zones. A test device may be a Bluetooth device which records current position, and Bluetooth devices.

Multiple test devices may be used. East test device should have different wireless hardware, with different power levels to validate different equipment ad zones. Multiple test devices may also be used to test different wireless technologies. Extracted from the test device will be a list of information. Each entry in the list may contain:

Location

List of wireless device addresses

Wireless technology used

The test device may either store the results on the device for later processing, or send measurements to a network based data collection point.

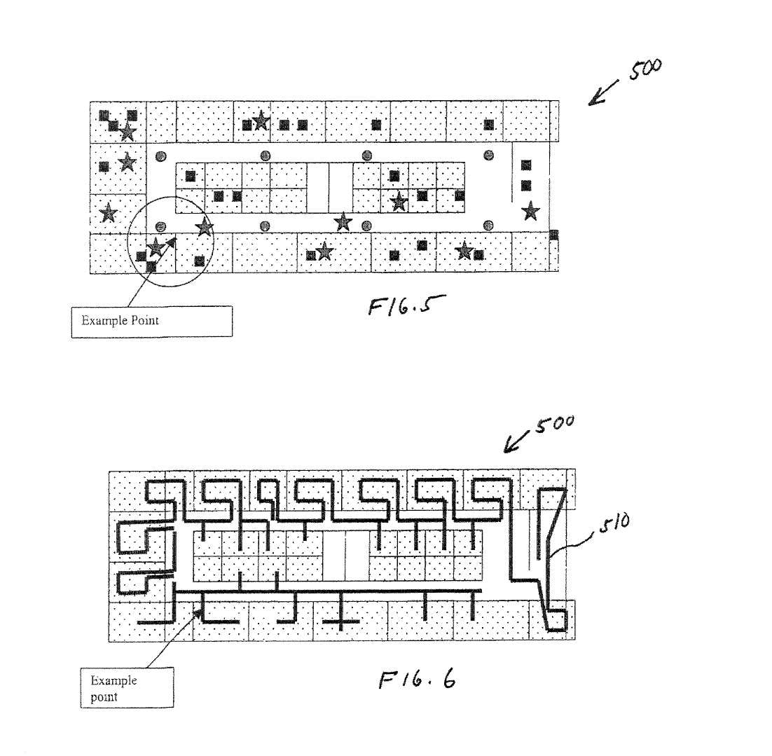

In an exemplary embodiment, consider a single floor office building 500, depicted in FIG. 5. Offices are shown as shaded areas. Phase 1 and Phase 2 initialization described earlier may be manually done. Within building 500 are many Bluetooth enabled devices. Stationary Bluetooth Devices are shown as squares, Mobile Bluetooth devices are shown as Xs, and access points are shown as circles. To initialize the system (Phase 3), a network administrator may travel around building 500 with a Bluetooth test device (depicted in FIG. 6). As the administrator walks around the building, the test device will record his location, and all Bluetooth enabled devices within range of the test device. The route 510 the administrator takes should cover as much of the building as possible. The administrator should walk slow enough that the test device can locate all Bluetooth piconets at each location. The administrator may manually enter (through a graphics map) his location as he walks, so that more precise location information may be recorded. At each test point the following may be recorded:

Location: 5 m, 3 m, 0 m (relative location within building to origin at lower left)

Addresses:

AD:AE:06:00:00:84 (LAN Access Point)

BB:44:06:00:00:67 (Cell Phone)

OC:67:06:AB:00:45 (Computer)

D1:B2:06:00:00:28 (Palm)

34:6E:26:00:00:22 (Printer)

78:CC:36:00:00:78 (Computer)

After the recording phase has been completed, the test device loads the recorded information into the location mapping system. The location mapping system transforms the recorded list, into its database. For the example point entry, the following filtering/classification may occur:

AD:AE:06:00:00:84 (LAN Access Point). Matched to permanent device.

BB:44:06:00:00:67 (Cell Phone). No address match, manufacture recognized as cell. Marked as mobile, ignored.

0C:67:06:AB:00:45 (Computer). Address matches to stationary device.

D1:B2:06:00:00:28 (Palm). Address matches to stationary device.

34:6E:26:00:00:22 (Printer). Address matches to stationary device.

78:CC:36:00:00:78 (Computer). Address matches to stationary device.

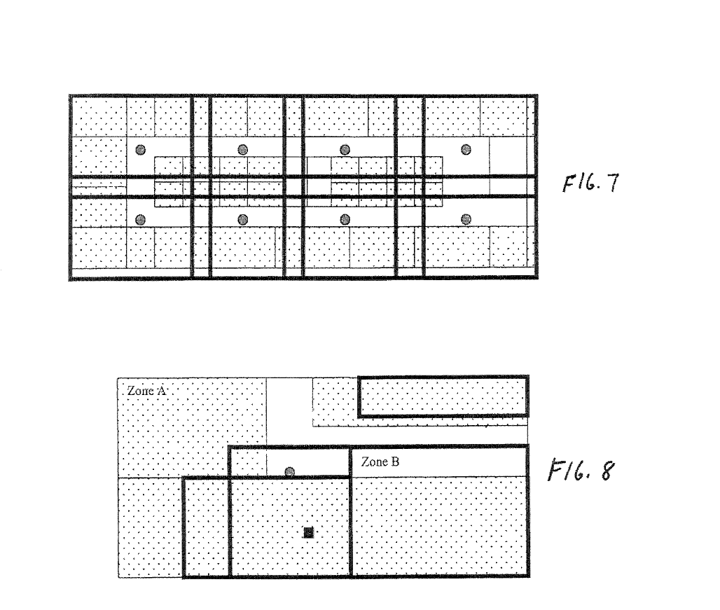

A cluster analysis may be used to determine and create the zones (highest layer, permanent base stations only) depicted in FIG. 7. An example of lower level zones for the lower left corner, for example, may be created as depicted in FIG. 8, in which:

Zone A is defined by

Include: AD:AE:06:00:00:84

Exclude: 0C:67:06:AB:00:45, 34:6E:26:00:00:22, 78:CC:36:00:00:78

Zone B is defined by

Include: AD:AE:06:00:00:84, 78:CC:36:00:00:78

Exclude: 0C:67:06:AB:00:45, 34:6E:26:00:00:22.

Each of the network access points is configured to scan to detect what Bluetooth devices (or other wireless devices) are within range. By providing such systems and methods as disclosed, mobile device users may have access to refined location information when operating within or near an area served by a communications network. Further, in some exemplary embodiment extraneous hardware, such as but not limited to GPS receivers are not required to gain such location information.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A method of determining location of a mobile device having a radio frequency (RF) transceiver, comprising:
gathering a list of addresses of nearby devices in communications with a network;
sending a location request to a location service accessible through the network accessed wirelessly by the mobile device;
accessing a database of known device locations;
correlating the list of addresses with zone information of the database.

2. The method of claim 1, further comprising:
receiving from the location service an estimated position of the mobile device.

3. The method of claim 1, wherein the estimated position includes a text based description.

4. The method of claim 1, further comprising:
providing an approximate position of the mobile device to the location service.

5. The method of claim 4, wherein the approximate position is determined by a global positioning system (GPS) device.

6. The method of claim 1, further comprising:
providing a reply to the location service that the estimated position is incorrect.

7. A method of determining location of a mobile device having a radio frequency (RF) transceiver, comprising:
receiving a location request from a mobile device over a communications network;
receiving from a mobile device a list of addresses of devices nearby the mobile device that are in communications with the communications network;
accessing a database of known device locations;
correlating the list of addresses with zone information of the database; and
sending a location estimation to the mobile device.

8. The method of claim 7, wherein the estimated position includes a text based description of the position.

9. The method of claim 7 further comprising:
receiving an approximate position of the mobile device.

10. The method of claim 9, wherein the approximate position is determined by a global positioning system (GPS) device.

11. The method of claim 7 further comprising:
receiving from the mobile device that the estimated position is incorrect.

12. A method of determining location of a mobile device having a radio frequency (RF) transceiver, comprising:
gathering a list of addresses of nearby devices in communications with a communications network;
sending a location request to a location service accessible through the network accessed wirelessly by the mobile device, the location service being configured to access a database of known device locations and to correlate the list of addresses with zone information of the database; and
receiving from the location service a location estimation of the mobile device.

13. The method of claim 12, wherein the location estimation includes a text based description of the mobile device location.

14. The method of claim 12, wherein the location estimation includes a graphical description of the mobile device location.

15. The method of claim 12, further comprising:
providing an approximate position of the mobile device to the location service.

16. The method of claim 15, wherein the approximate position is determined by a global positioning system (GPS) device.

17. The method of claim 12, further comprising:
providing a reply to the location service that the estimated position is incorrect.

18. A system for locating a wireless device in wireless communications with a communications network, comprising:
access points coupled to the communications network and being configured to communicate with the wireless device;
at least one other device in communication with the communications network;
a server coupled to the communications network, the server configured to receive location requests from the wireless device, the location request including a list of addresses of devices coupled to the communications network that are nearby the wireless device, the server configured to correlate the list of addresses with an estimated location, and the server is configured to send the estimated location to the wireless device.

19. The system of claim 18, wherein the wireless device includes a Bluetooth transceiver.

20. The system of claim 18, wherein the wireless device includes an IEEE 802.11 transceiver.

21. The system of claim 18, wherein the at least one other device includes a printer.

22. The system of claim 18, wherein the at least one other device includes a computer.

23. The system of claim 18, wherein the wireless device is configured to provide the estimated location of the wireless device on a graphical map.

24. A method for developing a database for a location determination service, comprising:
building a map of an area served by a network;
entering the locations of stationary and permanent devices and the associated device addresses into a database;
recording, using a test device, multiple locations accessible wireless addresses;
combining the map, the locations of stationary and permanent devices, and the accessible locations into the database; and
defining coverage zones of the area served by the network.
